(19) United States
(12) Patent Application Publication
(10) Pub. No.: US 2023/0068795 A1
(43) Pub. Date: Mar. 2, 2023

(54) Dual-purpose desktop Charger

(71) Applicants: Chen Guo, Columbus, OH (US); Weida Tan, Birmingham, AL (US)

(72) Inventors: Chen Guo, Columbus, OH (US); Weida Tan, Birmingham, AL (US)

(21) Appl. No.: 17/410,127

(22) Filed: Aug. 24, 2021

(51) Int. Cl. H02J 7/00; H02J 50/10

(52) U.S. Cl. CPC H02J 7/0044; H02J 50/10; H02J 7/0047; H02J 2207/30

(57) ABSTRACT

A Dual-Purpose Desktop Charger for compensating for the various sizes of personal electronic devices. A dual-purpose charger that includes a multi-port wired charging panel with the integration of an axel mechanism that allows for a multi-positional wireless charging pad.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable

### STATEMENT REGARDING FEDERALLY SPONSORED RESEARCH OF DEVELOPMENT

Not Applicable

### REFERENCE TO SEQUENCE LISTING OR COMPUTER PROGRAM LISTING APPENDIX

Not Applicable

### BACKGROUND

This disclosure generally relates to charging mobile devices and, in particular, relates to charging batteries utilized in many personal electronics.

Mobile devices, such as laptops, mobile phones, smartwatches, and the like, require regular charging of their batteries and have become a daily part of our lives. However, the chargers of today are limited and create problems frequently experienced by users.

A prior art search revealed a number of patents and patent applications related to wireless charging, but none have solved all of these problems. Prior art wireless charging products position the mobile charging device upright or nearly flat with respect to the surface the charger rests. The prior art wireless chargers are not versatile enough to rotate to accommodate a more extensive variety of mobile devices.

There exists a long-felt need for a wireless charging device that provides for not only the ability to charge multiple devices simultaneously but also the functionality to rotate to accommodate various sizes of devices to be charged. There exists in the prior art a long-felt need for a Dual-purpose charging device that allows for a mobile device to charge at any position.

### BRIEF SUMMARY

This section provides a general summary of the disclosure. It is not a comprehensive disclosure of its full scope or all of its features.

In accordance with various embodiments described herein, a Dual-Purpose Desktop Charger is provided, which may be selectively used in a variety of different ways. For example, the Dual-Purpose Desktop Charger allows for the positioning of a wireless charging pad in a variety of orientations to accommodate a variety of smart devices of designs in the prior art.

In one embodiment, a Dual-Purpose Desktop Charger may be implemented with a housing incuding a terminal to receive a power input, a control circuit including a gallium nitride semiconductor functionally connected to a plurality of charging ports, a wireless charging pad, and an axle mechanism designed to support a wireless charging pad to allow for adjustment of position and orientation of the charging pad.

### BRIEF DESCRIPTION OF THE SEVERAL VIEWS OF THE DRAWINGS

FIG. 1 is the perspective side view of the charger with the axle in the upward position.

FIG. 2 is the perspective side view of the charger with the axle and charging station in the upward position.

FIG. 3 is the rear perspective view of the charger with the axle and charging pad in the upward position.

FIG. 4 is a perspective side view of the dampening shafts of the axle mechanism.

### DETAILED DESCRIPTION

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment.

Throughout the specification and claims, the following terms take at least the meanings explicitly associated herein, unless the context dictates otherwise. The meanings identified below do not necessarily limit the terms but merely provide illustrative examples for the terms. The meaning of “a,” “an,” and “the” may include plural references, and the meaning of “in” may include “in” and “on.” The phrase “in one embodiment,” as used herein, does not necessarily refer to the same embodiment, although it may.

The term “coupled” means at least either a direct electrical connection between the connected items or an indirect connection through one or more passive or active intermediary devices. The term “circuit” means at least either a single component or a multiplicity of components, either active and/or passive, that are coupled together to provide a desired function. Terms such as “wire,” “wiring,” “line,” “signal,” “conductor,” and “bus” may be used to refer to any known structure, construction, arrangement, technique, method and/or process for physically transferring a signal from one point in a circuit to another. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

The terms “controller,” “control circuit” and “control circuitry” as used herein may refer to, be embodied by or otherwise included within a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. A general purpose processor can be a microprocessor, but in the alternative, the processor can be a microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

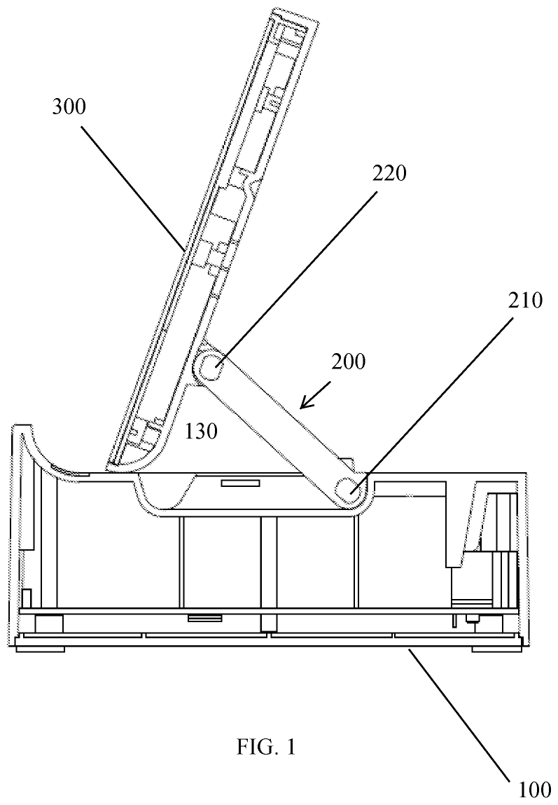

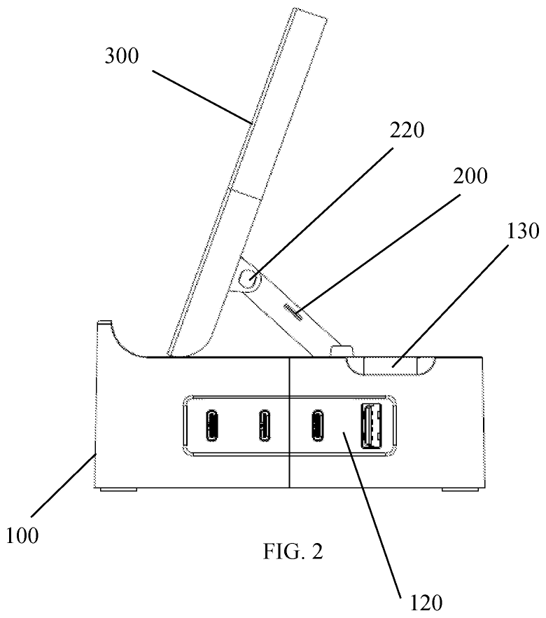

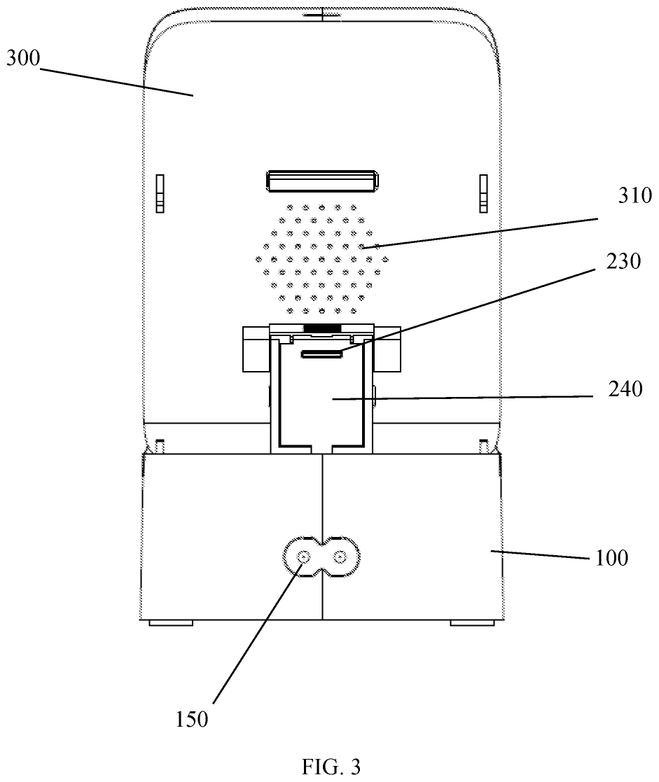

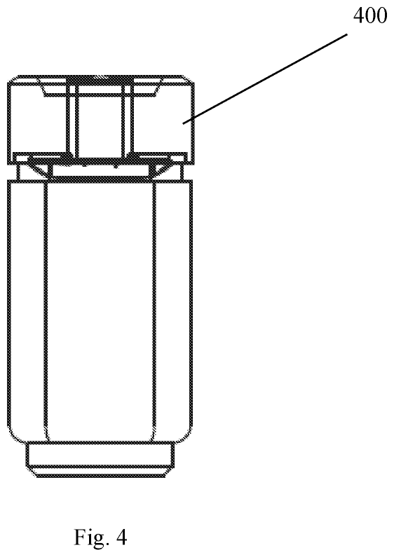

Referring generally to FIGS. 1-4, various exemplary embodiments of a Dual-purpose Desktop Charger may now be described in detail. Where the various figures may describe embodiments sharing various common elements and features with other embodiments, similar elements and features are given the same reference numerals, and redundant descriptions thereof may be omitted below.

As illustrated, reference number 700 refers to a Dual-Purpose Desktop Charger, including a first charger assembly housing 100. In one embodiment, the first charger assembly housing 100 may be rotationally coupled to an axle mechanism 200 at a first end of the axle mechanism 210. In certain embodiments, a second end of the axle mechanism 220 is rotationally coupled to the second charger assembly housing 300. Advantageously, the axle mechanism 200 allows the rotational pivot of the second charger assembly housing 300 from vertical to horizontal.

In an exemplary embodiment, the axle mechanism 200 is slidably connected to the first charger assembly housing 100 within an undercut channel 130 on the top of the first charger assembly housing 100, which allows for the second charger assembly housing 300 to rest flush with the top of the first charger assembly housing 100. In other embodiments, the axle mechanism 200 includes a locking mechanism 230 to allow for the second charger assembly housing 300 to be fixed upright positioned to accept an external device to be charged. Advantageously, the locking mechanism 230 is designed to output an audible clicking noise upon being locked into a user's desired position.

In certain embodiments, the axle mechanism 200 includes an adjustable support arm 240 with an aperture on each end 220 that is designed to accept a dampening shaft 400. Advantageously, the dampening shaft 400 is configured to allow the sliding and locking of the support arm 240 into a user's desired position.

In some embodiments, a Dual-Purpose Desktop Charger includes a control circuit disposed within the housing 100 that is operably connected to a power input terminal 150. The power input terminal 150 may be configured to accept an AC power source. In certain embodiments, the control circuit utilized a gallium nitride semiconductor.

In certain embodiments, the first charger assembly housing 100 includes a plurality of charging ports 120 operably connected to the control circuit and mounted to the side of the first charger assembly housing 100. In some embodiments, the control circuit disposed within the housing 100 is configured to transmit an output power signal to the plurality of charging ports 120 corresponding to the type of smart device being connected via an exterior charging cable. Optionally, the plurality of charging ports 120 may allow access to a control circuit and a battery source disposed within the housing 100. When operable, an external device may receive power transmitted from the control circuit of the Dual-purpose Desktop Charger 700 indicative of the charging port utilized. The external device may be operable connected to the plurality of charging ports 120 by direct connection and configured to communicate via PD 3.0 (Power Delivery), PPS (Programmable Power Supply), QC (Quick Charge), SCP (SuperCharge Protocol), or other standardized communication protocol.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A dual-purpose desktop charging apparatus, the device comprising:
A first charging house assembly having at least one first base terminal for the input of electrical power, the first charging house assembly including at least one second base terminal placed on a second housing terminal housing of said charger housing assembly for output of said electrical power;
A control circuit disposed within said charging house assembly, the control circuit configured to transfer power from an external input;
A gallium nitride semiconductor disposed within the said first charging house assembly and designed to receive power input from the said control circuit;
A plurality of charging ports disposed on a side of the first charging house assembly, configured to receive a variety of external charging cables, the said plurality of charging ports configured to receive a power output from said gallium nitride semiconductor;
An axle mechanism with one distal end functionally connected to said first charging house assembly and a second distal end connected to said second charging assembly;
A second charging assembly having at least one wireless charging pad, rotationally connected to the axle mechanism;

2. The dual-purpose desktop charging apparatus of claim 1, wherein the axle mechanism comprises:
At least one support arm having a first distal end, said first distal end slidably mounted to the said first charging housing assembly, the at least one support arm including a second distal end rotatably attached to said second charging assembly;
Wherein the at least one support arm is configured to allow the second charging assembly to set at various angles relative to the said first charging assembly;
Wherein the at least one support arm is designed to interchangeably support the said second charging assembly horizontally or vertically;

3. The dual-purpose desktop charging apparatus of claim 1, wherein the second charging assembly further comprises a plurality of charging coils configured for wireless charging of an external device;

4. The dual-purpose desktop charging apparatus of claim 1, wherein the plurality of charging ports are a combination of USB-A or USB-C;

5. The dual-purpose desktop charging apparatus of claim 1, wherein the first charging house assembly includes an LED display light;

6. The dual-purpose desktop charging apparatus of claim 1, wherein the axle mechanism further comprises a locking mechanism configured to emit an audible click when said axle mechanism is locked into position;

7. The dual-purpose desktop charging apparatus of claim 1, wherein the axle mechanism is designed to support the second charging house assembly at an angle of 70 degrees relative to the first charging house assembly;

8. The dual-purpose desktop charging apparatus of claim 1, wherein the first charging house assembly further comprises a lip configured to accept the second charging house assembly;
